(19) United States
(12) Patent Application Publication
(10) Pub. No.: US 2009/0322597 A1
(43) Pub. Date: Dec. 31, 2009

(54) LOCATION METHOD AND SYSTEM AND LOCATABLE PORTABLE DEVICE

(75) Inventors: Miguel Angel Medina Herrero, Madrid (ES); Alejandra Diaz Diaz, Madrid (ES)

Correspondence Address: KNOBBE MARTENS OLSON & BEAR LLP, 2040 MAIN STREET, FOURTEENTH FLOOR, IRVINE, CA, 92614, US

(73) Assignee: NAVENTO TECHNOLOGIES, S.L., Madrid (ES)

(21) Appl. No.: 12/112,891

(22) Filed: Apr. 30, 2008

(30) Foreign Application Priority Data
Apr. 30, 2007 (ES) P200701166
Mar. 14, 2008 (ES) P200800757

(51) Int. Cl. G01S 1/00

(52) U.S. Cl. 342/357.02

(57) ABSTRACT

Location method for locating a portable device (1) from a server (2) configured to communicate with said portable device (1) through a wireless communications network (3), in which said portable device (1) comprises a transmission/receiving module (12), an A-GPS positioning module (11) and a microprocessor (15) configured to manage said modules (11, 12), in which the method comprises the steps of: sending GPS assistance information from the server (2) to the portable device (1) through said wireless communications network (3); obtaining in an A-GPS positioning module (11) of the portable device (1) a GPS signal (4) from a satellite system (8); calculating in said portable device (1) a location of the device (1) itself from said GPS signal (4) and from the GPS assistance information sent by the server (2); sending said location to the server (2) from the transmission/receiving module (12) through said wireless communications network (3). It also comprises the steps of: when the portable device is stopped, hibernating the A-GPS positioning module and the microprocessor, maintaining the transmission/receiving module turned on; and when the portable device is in an area in which it is receiving service from said wireless communications network from a cell recognized by said device and stored in a memory thereof, turning off the A-GPS positioning module, such that the server can provide position information associated to said area without having to interrogate the device, thus saving the battery and increasing the autonomy of the portable device.

### FIELD OF THE INVENTION

The present invention relates to the field of location methods and systems and more specifically to those directed towards social-sanitary environments for locating the elderly, children, sickly and handicapped persons.

### BACKGROUND OF THE INVENTION

The conventional GPS system is made up of a network of satellites in non-geostationary orbit, a network for controlling and maintaining the network of satellites and a series of receivers that can calculate their approximate position on the surface of the Earth.

The conventional GPS system has certain limitations mainly because of the low power emitted by the satellites and the low sent information transmission rate. These characteristics mean that the Time to First Fix (TTFF) is high (several minutes). The receiving capacity is furthermore generally limited to areas with directive visibility of the satellites.

International patent application WO2006/000605 describes a device for the analysis of the activity of a person and for the automatic detection of falls. The person's position is detected by means of a conventional GPS system and, continuously measures the acceleration of the (by means of an accelerometer) for the purpose of monitoring if the person falls to the ground, such that the fall is associated with a certain instantaneous acceleration value. This device is designed for fall detection, but its efficiency is low as an absolute position detector, especially in interior spaces, where GPS signals easily lose coverage.

Patent document U.S. Pat. No. 5,874,897 describes a remote care system comprising a portable device with a GPS unit and a series of sensors of certain medical parameters of the patient which are transmitted to a monitoring unit in the event of relevant changes in these medical parameters, so that someone comes in aid of the carrier of the device.

The conventional GPS model has been improved by the use of A-GPS (Assisted GPS) technology, which has a direct effect on the TTFF and on receiver sensitivity, broadening reception to areas without direct visibility. In addition to communication with GPS satellites, A-GPS technology is based on the use of certain additional information or assistance which is received by other external means or elements (such as a system server) which aids in locating the receiver.

This assistance can comprise approximate device position information, information on the position of the satellites and/or clock information. According to the manufacturer and the system, the assistance information is formed by the three types of information mentioned or by just one of them.

With the assistance information, which has a time validity and is therefore periodically downloaded from the server to the receiver device, the following improvements occur: the TTFF (GPS signal acquisition times) is reduced, since the receiver is more quickly synchronized with the signal of the satellites and does not require decoding said signal, as it knows a priori the information it is going to receive from them. The time required for location is therefore reduced; the location sensitivity and precision is increased, allowing to fix the position in complicated environments, such as large urban and interior environments; battery consumption is reduced, increasing the autonomy of the system.

On the other hand, one of the main problems in portable location devices is the little autonomy they have, i.e. the reduced number of hours of use they allow without needing to charge the battery. The difficulties in the attempts to improve the maximum charge of the batteries of these devices have led designers of such devices to optimize the consumption control systems of these devices, allowing the main modules to hibernate if they are not used for a certain time period. Therefore, for example, in location devices using mobile telephony (GSM/GPRS) to transmit their position, consumption of the devise is also reduced to a minimum in the case of being connected to the mobile telephony network (GSM/GPRS) from cells known by the system and associated to certain already defined areas.

Japanese patent application JP11083529 describes a device which can be located as a result of the combination of a GPS receiver, an accelerometer and a gyroscope. Thanks to this combination, the system tries to minimize battery consumption. However, location of the device is always carried out locally in the device itself, without making use of an external element such as a server, slowing down the calculation and jeopardizing location efficiency.

Japanese patent application JP10221427 also describes a device which can be located by means of a GPS positioning system, in which a transmission module is turned off when GPS coverage is lost. The battery is thus saved. However, as in the previous case, location of the device is also achieved locally, thereby not optimizing the calculation and jeopardizing the efficiency of the location.

Although there are systems making use of the aforementioned A-GPS location technology, the normal operation of these systems consists of having the A-GPS module turned off until a location request is received. Unfortunately switching said A-GPS module from off to on affects the autonomy of the device, since the consumption of energy derived from turning on and completely activating an A-GPS module, with the signaling and information exchange involved, is very high.

### SUMMARY OF THE INVENTION

The present invention solves the aforementioned problems by means of a method which, thanks to the combination of the use of sensors present in the portable device and of the use of A-GPS location technology, allows reducing the battery consumption of a GPS location system. In other words, the autonomy of the device increases and the quality of the system is improved since the location time of the device and the battery consumption is reduced and precision of the obtained location is increased.

In one aspect of the present invention, a location method of a portable device from a server configured to communicate with said portable device through a wireless communication network is provided, in which said portable device comprises a transmission/receiving module, an A-GPS positioning module and a microprocessor configured to manage said modules. The method comprises the steps of: sending from the server to the portable device GPS assistance information through said wireless communication network; obtaining in an A-GPS positioning module of the portable device a GPS signal coming from a system of satellites; calculating in said portable device a location of the device itself from said GPS signal and from the GPS assistance information sent by the server; sending said location to the server from the transmission/receiving module through said wireless communications network. The method further comprises the steps of: hibernating the A-GPS positioning module and the microprocessor when the portable device is stopped, maintaining the transmission/receiving module turned on; and turning off the A-GPS positioning module when the portable device is in an area in which it is receiving service from said wireless communications network from a cell recognized by said device and stored in a memory thereof, such that the server can provide position information associated to said area without having to interrogate the device, thus saving battery and increasing the autonomy of the portable device.

The step of hibernating said module and said microprocessor is preferably carried out by the portable device itself according to at least the information obtained from motion sensor means which can detect the motion of said device.

The portable device preferably calculates, from said information comprised in said GPS signal, the speed of the device itself, said information relating to the speed of the device being used to make the decision to hibernate said module and said microprocessor.

Before the step of hibernating said module and said microprocessor the device sends to the server: the last location obtained by the A-GPS positioning module, previous locations stored in the device, if any; and informs the server that it is to hibernate said module and said microprocessor.

Said calculation of the location of said device can be carried out either in an on demand mode, i.e. as a response to an occasional request of a user made through said server, or in a tracking mode, i.e. it is periodically repeated every certain time period, provided that there is GPS coverage, at the request of a user determining said time period through said server.

If the device loses coverage of the wireless communications network, the device stores in a local memory all locations calculated according to said tracking mode and which have not been sent to the server due to a lack of coverage of the wireless communications network, and they are sent to the server when the device recovers said coverage.

The device can change the mode for obtaining locations from on demand mode to tracking mode at the request of the user through said server and vice-versa.

If the A-GPS positioning and transmission/receiving modules are turned on, GPS coverage is lost by the A-GPS positioning module, the portable device sends to the server: the last location obtained by the A-GPS positioning module, and previous locations stored in the device, if any; and informs the server that it has lost GPS coverage.

If the device starts to move after having been stopped and with the A-GPS positioning module hibernated, these steps occur: turning on the A-GPS positioning module, informing the server of the turning on of said module and that it is attempting to obtain GPS coverage.

The portable device can be voluntarily turned off by means of a encoded key or automatically by using up the battery of the actual portable device. Before being turned off, the device: informs the server that it is going to turn off; sends the server the last location obtained by the A-GPS positioning module and sends the server previous locations stored in the device, if any.

When the portable device is turned on, the following steps occur: both A-GPS positioning and transmission/receiving modules are activated, the device starts to search for GPS coverage and the device informs the server of this.

When the portable device obtains GPS coverage and has the A-GPS and transmission/receiving modules turned on: it informs the server of this and sends it its current location.

If the portable device loses coverage of the wireless communications network and is in motion, the device: continues calculating its locations from said GPS signal and from the sent GPS assistance information, and stores said locations in a memory of the device in order to be sent to the server when the device has recovered said coverage of the wireless communications network.

Each time the device sends the server any of the locations obtained in the A-GPS positioning module, it also includes the time associated to each of said locations.

The server is configured to inform a user of the position of the portable device. If the device is stopped, the server sends the user the last position of the device which the server has stored, where said last position has been sent from the device to the server before hibernating the A-GPS positioning module. If before being stopped the device has both GPS coverage and coverage of the wireless communications network, it informs the user that the information of the location sent corresponds with the current position of the device. If before being stopped the device does not have GPS coverage, it informs the user that the information of the location sent cannot correspond with the current position of the device, in which case said information corresponds with the last position which the device could calculate before losing GPS coverage. If the device is in motion but has lost GPS coverage, the server sends the user the last position of the device which the server has stored, where said last position has been sent from the device to the server before losing GPS coverage, and the server informs the user that: the information of the location sent cannot correspond with the current position of the device, but rather it corresponds with the last position which the device could calculate before losing GPS coverage and that the device is searching for GPS coverage. If the device is turned off, the server sends the user the last position of the device which the server has stored, and the server informs the user that: the information of the location sent cannot correspond with the current position of the device, that the device is turned off.

The user receives the position of the portable device in a form which is is chosen as follows: represented on a cartographic map accessible from a fixed terminal or from a mobile terminal, represented in text format, or by means of an audio file.

The method also allows sending to a user at least one alert related to the state of the portable device. This alert is chosen from among the following group of alerts: motion alert, geographical alert, speed alert, low battery alert, panic alert and fall alert.

The service and management of said alerts is configured by means of web access from a computer, from a mobile terminal or by means of telephone access. The user can receive the alert from the server by means of sending an SMS to the mobile of the user, by means of sending an e-mail to his or her e-mail address or by means of a voice call to his or her mobile or fixed telephone.

In another aspect of the present invention, a portable device is provided comprising: global A-GPS positioning means configured to receive a GPS signal from a network of GPS satellites; transmission/receiving means configured to connect to a wireless communications network and to receive therethrough from a server at least GPS assistance information and location requests; a microprocessor which can control said A-GPS positioning means and said transmission/receiving means and comprising an internal storage memory; in which said portable device can calculate its position from said GPS assistance information and from the GPS signal and send said position to said server. The portable device further comprises motion sensor means that can capture information which can be used to hibernate or interrupt the hibernation of said A-GPS positioning module, according to the absence or presence of motion of the portable device and which can capture a measurement of gravity.

The motion sensor means preferably comprise an accelerometer. The device preferably comprises a battery, an access interface, visual means for indicating the state of said battery, of said A-GPS positioning means and of said transmission/receiving means.

In another aspect of the present invention, a location system for locating a portable device is provided comprising: at least one portable device like the one previously mentioned; a server configured to communicate through a data channel with said portable device through a wireless communications network and to automatically provide said portable device GPS assistance information; a remote manager node connected to said server through a data network, configured for the remote management of the device. The server comprises a sub-system of GPS assistance information, in turn comprising a database which can store the assistance information itself, in charge of the steps for obtaining, treating and sending the GPS assistance information from the server to the device. The server further comprises a geographic information sub-system in turn comprising a cartographic database which can store maps, in which said geographic information sub-system of geographical information is configured to manage actions relating to cartography requests, positioning on said cartography of the location of the device, geocoding and reverse geocoding. The server further comprises a user management sub-system, in turn comprising a database which can store information associated to the users, in which said user management sub-system is configured to manage the registration, cancellation, permissions, privacy, security and spatial temporal preferences of the users.

Finally, the invention provides a computer program comprising computer program code means adapted to carry out the steps of the previously described method when the mentioned program is executed in a computer, a digital signal processor, an application-specific integrated circuit, a microprocessor, a microcontroller or any other form of programmable hardware.

The invention further provides other embodiments as they are described in the dependent claims.

Thanks to the fact the device of the present invention is equipped with the latest technologies based on satellite-assisted location (A-GPS) and mobile communications, high precision can be reached in each of the A-GPS locations carried out.

The service quality of this GPS location system is measured through the response time of the location, of the precision of the location obtained and of the battery consumption of the device.

In other words, and in short, a system is obtained having a service quality that is greater than a conventional GPS system. The high autonomy of the device furthermore does not jeopardize the efficiency thereof or the high service quality achieved, represented by the quick response to the position requests made by a user and by the high probability of a reliable response. This system can even provide the real position of the device to the user, without needing to communicate with the device, the device further being in a low energy consumption mode.

The possibility of configuring and making use of a series of alerts enhancing the functionalities defined in the method is further added.

### BRIEF DESCRIPTION OF THE DRAWINGS

For the purpose of aiding in better understanding the features of the invention according to a preferred practical embodiment thereof and to complement this description, a set of illustrative and non-limiting drawings is attached as an integral part thereof. In these drawings:

FIG. 1 shows a diagram of the location system according to an embodiment of the present invention.

FIG. 2 shows a diagram of a portable device which can be located by means of the method and system of the present invention.

FIG. 3 shows a diagram of a server of the location system of the present invention.

FIG. 4 shows the state diagram of the operating algorithm of the method and system of the present invention.

FIG. 5 shows the flow chart of the operating algorithm of the method and system of the present invention.

### DETAILED DESCRIPTION OF THE INVENTION

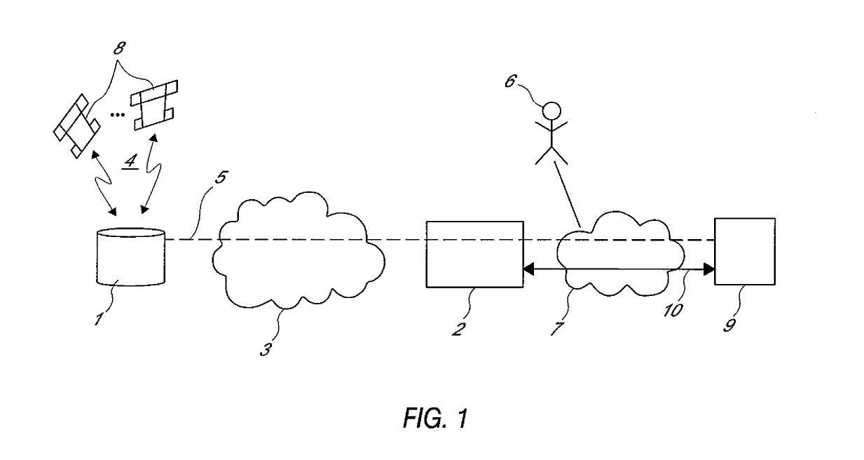

FIG. 1 shows a diagram of the location system. The system comprises a server 2 and one or several portable devices 1 which can be located. FIG. 1 shows a single portable device 1. Communication between the server 2 and the portable device 1 is set up through a wireless communication network 3. Non-limiting examples of possible wireless communication networks are GSM, GPRS, CDMA, PHS, EDGE, UMTS, FOMA, CDMA2000, TD-SCDMA, HSDPA, HSUPA, WiFi, WiMAX and Bluetooth. This wireless communication network 3 is preferably a GSM/GPRS network.

The device 1 can receive GPS signals 4 from a system of satellites 8. The device 1 further receives GPS assistance information (A-GPS) from a server 2 on the communications channel 5 existing on the wireless communications network 3. Said communications channel 5 between the device 1 and the server 2 includes both data communication and voice communication. The communications channel 5 is not limited to being set up between the device 1 and the server 2, but rather it can also be set up between the device 1 and an Alert Management Center 9 for an emergency call explained below, or between the device 1 and another telephonic device.

In order for an authorized user 6 to be able to access the information on the location of the device 1 and carry out all the steps and configurations typical of the described service, the user 6 must access the server 2 through a communications network 7. This network 7 can be either a data network from a computer personal, the Internet for example, or a mobile communications network from a mobile terminal or PDA, such as GSM, GPRS.

This architecture further comprises an outer node called Alert Management Center (AMC) 9 connected to the server 2 which aids in managing the service in order to communicate alerts from the platform or server 2. The AMC 9 can be included within the server 2. In the event that it is not included and they are separate nodes, the communications network 7 for accessing the server is used in order to communicate between both, on which network a communications channel 10 is provided. Said communications channel can include data and voice communications.

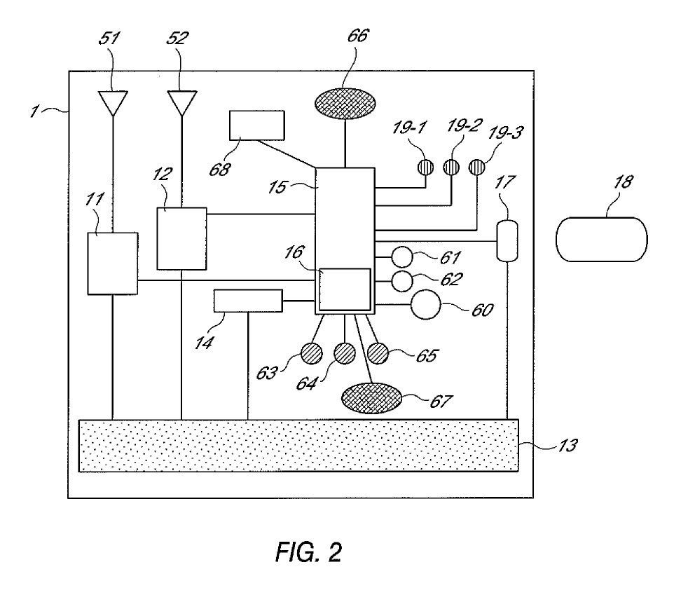

FIG. 2 shows a diagram of the portable device 1. The device 1 is wireless. The device 1 comprises an A-GPS positioning module 11 comprising a preferably four-band GPS receiver. Through this A-GPS positioning module 11, the device 1 can receive GPS signals 4 from a system of satellites 8, GPS assistance information (A-GPS) from a server 2 and can continuously calculate its location provided that it has GPS coverage. Both the GPS signals 4 and the system of GPS satellites 8 are schematically shown in FIG. 1.

The portable device 1 also comprises a transmission/receiving module 12 through which the device 1 communicates with the server 2. This module 12 comprises the conventional elements for setting up wireless communication on a mobile network, such as mobile communications modem, a transmitter/receiver and a SIM card. This module 12 allows the device 1 to operate as a mobile communications terminal, both as a conventional and as a hands-free cellular telephone.

The device 1 further comprises a motion sensor 14, which can measure at least the acceleration of the device 1 and thus determine if the device is in motion or at rest (stopped). The motion sensor can also measure at least the gravity value, which is useful for knowing the degree of inclination of the device 1 on the 0° horizontal. The motion sensor 14 is preferably an accelerometer.

The motion sensor 14, preferably an accelerometer, and more preferably having three axes, allows, together with other aspects indicated below, from a microprocessor or microcontroller 15 switching the A-GPS positioning module 11 to a low consumption or hibernated mode, with the subsequent prolongation of the life of the battery 13 or increase in the autonomy of the device 1. In this transition, the microprocessor 15 will also operate in a low energy consumption mode.

In the context of the present invention, “hibernating” is understood as the action of switching a device or device module to a low operating activity and minimum energy consumption state.

In this sense, in the context of the present invention “hibernating an A-GPS positioning module” is understood as the action of switching said module to a state in which the following actions are not carried out: listening and processing GPS signals from satellites, calculating positions and calculating the speed of the device comprising this module. Energy consumption is thus minimized.

Likewise, in the context of the present invention, “hibernating a microprocessor of a device” is understood as the action of switching said module to a state in which the only thing it does is wait to receive any signal from a motion sensor and/or from the transmission/receiving module 12, in which case the microprocessor sends an order to turn on the A-GPS positioning module. Energy consumption is thus minimized.

It must be clarified that switching a device from hibernation to on has an energy consumption that is much lower than switching from turned off to turned on, which has a high energy consumption peak.

In the context of the present invention, “turning on” is understood as the action of switching a device or device module to a normal activity or full efficiency state, with the subsequent energy consumption. This term “turning on” is applied both to a device and to the A-GPS positioning module, transmission/receiving module, motion sensor and microprocessor comprised in said device.

Finally, in the context of the present invention, “turning off” is understood as the action of switching a device or device module to a nil activity state and therefore a state with no energy consumption. This term “turning off” is applied both to a device and to the A-GPS positioning module, transmission/receiving module, motion sensor and microprocessor comprised in said device.

As has already been mentioned, the device 1 also comprises a microprocessor or microcontroller 15, which in turn comprises an information storage means or memory 16. This memory 16 is useful for storing the GPS assistance information (A-GPS) sent from the server 2 to the device 1, local locations carried out by the device 1 and which are not sent by the server 2 due to several circumstances, such as not having coverage of the wireless communication network 3 or because it is designed for this local storage. Information relating to service alerts and information of the cells or base stations of the wireless communications network 3, associated to areas predefined as known areas, can also be stored in this internal memory 16.

The microprocessor 15 and the A-GPS positioning module 11 can be in three possible states: off state, involving no energy consumption, on state, involving a normal energy consumption, or low consumption or hibernated state, involving an energy consumption that is lower than the previous state and therefore prolongs the life of the battery of the device 1. In the low consumption or hibernated state, the A-GPS positioning module 11 does not process the GPS signal 4 from the satellites 8 or calculate the positions or the speed of the device 1. The transmission/receiving module 12 and the motion sensor 14 can be in two possible states: on state, involving a normal energy consumption, or low consumption or hibernated state, but never in off state.

The device 1 also has a power supply battery 13, to supply the modules or elements thereof requiring it. The system prolongs the life of said battery 13 to increase the autonomy of the device 1 with respect to other devices using conventional or autonomous GPS technology.

The device 1 preferably also comprises an access interface 17. This access interface 17 is preferably a USB port, more preferably a mini-USB port. This access interface 17 can be used as access to several elements, such as the power supply connector of the battery 13, for updating the firmware and the configuration of the device, or as access to a encoded key 18 for safely turning on/off the device 1 and without risk of manipulation or turning off by persons who are not authorized to turn it off. This is achieved by means of the univocal association between the device 1 and an encoded key 18 which is only valid for a USB belonging to the carrier of the device. This key 18 is shown in FIG. 2. For example, the encoded key can be useful for turning off the device 1 when its carrier is on a plane or when the device is not going to be used for a long time period. The USB safety key can also preferably be encoded in order to prevent making a fraudulent copy by any unauthorized person. In the event of the loss of the encoded key 18, the device 1 can be turned off by the owner thereof connecting with and identifying himself or herself to the server 2 through a WEB service, or a mobile telephony application, or through a telephone call for example. Turning it off is also possible by holding down a button or key.

Through this USB interface the device 1 can optionally be interrogated through a specific software when it connects to a USB port of a PC, in turn connected to a server checking the firmware versions, configuration of the device, state of alerts. The device 1 can download a new firmware version via the Internet and update the device 1 through these USB ports.

The device 1 preferably also comprises visual indicators 19-1 19-2 19-3 providing the carrier of the device 1 with information on the state of several elements. For example, they can inform about the state of the battery 13, about whether the A-GPS positioning module 11 has coverage and about whether the transmission/receiving module 12 has coverage. These visual indicators are preferably LED diodes.

In a particular embodiment, the LED diodes 19-1 19-2 19-3 have the following functions: If a green light is blinking in a first LED 19-1, it means that the device 1 is turned on. If the green light is steady, it means that the battery 13 is charged and that the device 1 has a power supply from the battery 13 connected to the access interface 17. If a red light is blinking in said LED 19-1, it means that the battery 13 is low. If the red light is steady, it means that the battery 13 is being charged by means of a supply source. If an orange light is blinking in a second LED 19-2, it means that the device 1 has coverage of the mobile communication network 3. If a blue light is blinking in a third LED 19-3, it means that the device 1 has coverage of the system of GPS satellites 8.

The locator device 1 further comprises firmware included in its microprocessor 15, which can be remotely updated via OTA (Over The Air).

The device 1 also comprises an internal GPS antenna 51 and an also internal preferably four-band antenna for radio transmission/receiving 52.

The device 1 preferably comprises a loudspeaker 66 for transmitting or reproducing audio signals.

The device 1 preferably comprises a microphone 67 for receiving audio signals.

The device 1 can be preferably used as hands-free by means of a sufficiently sensitive microphone 67 and a loudspeaker 66 which can emit at sufficient power.

The device 1 further has an activation interface for activating a panic situation which, when activated by the effect of an action carried by the carrier of the device 1, communication between the transmission/receiving module 12 of the device 1 and the Alert Management Center 9 is set up. Said communication between the device 1 and the AMC 9 is set up at a previously established AMC 9 number (see FIG. 1) through the communications channel 5 and through the server 1.

This activation interface is preferably a button or key which the carrier can press 60, in which case the device 1 sends an alert and sets up a call to a previously configured telephone number. Alternatively, it is possible to activate it through the use of a word previously recorded in the memory 16 of the device 1: through a voice recognizer in the microphone 67, the microprocessor 15 can activate the panic situation.

This number preferably cannot be modified without prior authorization from the platform managers.

This activation or panic interface is associated to a panic alert which is mentioned below.

Pressing this panic button 60 always has associated thereto switching to the operation to the “tracking” mode in the event that the device 1 is operating in the on demand mode. These operation modes are explained below. This switching remains in this mode until the deactivation of the panic alert occurs, all of which is explained below.

Three possible configurations are defined below for this activation functionality:

A first configuration involves the device 1 sending an alert and a call to AMC through the server 2. It is preferably the default configuration of the device: Upon making a call, after pressing the key of the activation interface for a certain time period, a certain number of seconds for example, the device 1 emits a small “beep”. Then:
A panic alert frame managed by the server 2 is sent (including the location in the event of having it updated) and an ACK from the server 2 is waited for. There is a frame send re-try policy until receiving an ACK from the server, including a maximum possible configurable wait time. This alert preferably has priority over the remaining types of alerts, as explained below.
The AMC number pre-configured in the device 1 is dialed and a voice call is set up between device 1 and AMC 9 on the communications channel 5.
Once the call is finished, the device 1 sends an end of call frame to the server 2 detailing the following fields: [number B, type (incoming/outgoing), duration, GPS date (if any)]. In this case, the number B is that of the AMC and the type is outgoing.

A second configuration only involves sending an alert to the control platform: Upon making a call, after pressing the key of the activation interface for a certain time period, a certain number of seconds for example, the device 1 emits a small “beep”. Then:
A panic alert frame managed by the server 2 is sent (including the location in the event of having it updated) and an ACK from the server 2 is waited for. There is a frame send re-try policy until receiving an ACK from the server, including a maximum possible configurable wait time. This alert preferably has priority over the remaining types of alerts, as explained below.
The platform subsequently sends a frame to the AMC on the communications channel 10 with the information of the alert in which the identity of the user is included.
The AMC makes a call to the user who can accept such call by making use of the interface 62 described below.
Once the call is finished, the device 1 sends an end of call frame to the platform detailing the following fields: [user id, number B, type (incoming/outgoing), duration, GPS date (if any)]. The number B in this case is that of the AMC and the type is incoming.

A third configuration only involves sending an AMC call: Upon making a call, after f pressing the key of the activation interface for a certain time period, a certain number of seconds for example, the device 1 emits a small “beep”. Then:
The AMC number pre-configured in the device is automatically dialed.
When the call is finished, a panic alert frame is sent to the platform (including the location in the event of having it updated) and an ACK from the platform is waited for. There is a frame send re-try policy until receiving an ACK from the server, including a maximum possible configurable wait time.
Once the call is finished, the device 1 sends an end of call frame to the platform detailing the following fields: [user id, number B, type (incoming/outgoing), duration, GPS date (if any)]. The number B in this case is that of the AMC and the type is outgoing.

Furthermore the device 1 has a button or key for receiving a call 62. This button preferably has a color which is associated to an incoming call, green for example, to facilitate its identification. This incoming call button allows accepting an incoming call.

The device 1 additionally has warning means 68 (sound and/or vibration) for incoming calls.

The device 1 also has a button or key for ending a call 61. This button preferably has a color which is associated to an ended call, red for example, to facilitate its identification. This ended call button allows hanging up or interrupting a call. It can also be configured to turn on/turn off the device 1. It is therefore a configurable button. This functionality can be blocked by the user 6 from the configuration of the device 1 in order to disable turning off the device 1 making use of the interface or button 61. Sending an end of call frame is emphasized among the functionalities associated to this end call button.

The turning off functionality can also be done remotely, the device 1 can process a frame from the server 2 and it can optionally have been generated in the AMC 9, requesting turning off device 1.

Upon ending a call through the interface 61, the device 1 sends an end of call frame to the server 2 detailing the following fields: [id user, number B type (incoming/outgoing), duration, GPS date (if any)].

The device 1 optionally has quick call buttons or keys. Each of them allows making pre-established calls to a number associated to the corresponding button chosen by the user. Upon making a call, after holding down this key for a certain interval of time, the device 1 emits a small beep to indicate that it is attempting to set up the call. These buttons can be configured to telephone numbers which the user 6 can configure through access to the service which was previously mentioned.

The device 1 preferably has three quick call buttons, 63, 64, 65.

During an ongoing call, the device 1 allows the following functionalities:
Raising/Lowering the volume of a call through the use of buttons 63 and 65. Button 63 allows lowering the volume of a call and button 65 allows raising the volume of the call. This functionality can be blocked by the user 6 from the configuration of the device 1.
Activating/Deactivating the hands-free functionality, making use of button 64. This functionality can be blocked by the user 6 from the configuration of the device 1.

The system further allows defining a set of alerts created by the user 6 through the server 2. In all possible alert cases, in the event that they occur, the system allows informing the user of the event in different ways, such as by means of a text message to his or her telephone mobile, by means of an e-mail to his or her e-mail address or by means of telephone call. These alerts are detailed below.

The device 1 also optionally comprises a gyroscope and a digital compass for achieving an estimation of the position in the absence of a satellite signal 4.

The device 1 also optionally comprises short range radio communication means, i.e. Bluetooth, infrared, or any other form of conventional short range radio communication for sending the position to other devices 1 having these same means.

Any of the conventional GNSS (Global Navigation Satellite System) systems, such as GPS, Galileo, GLONASS can also optionally be used as a system of satellites 8.

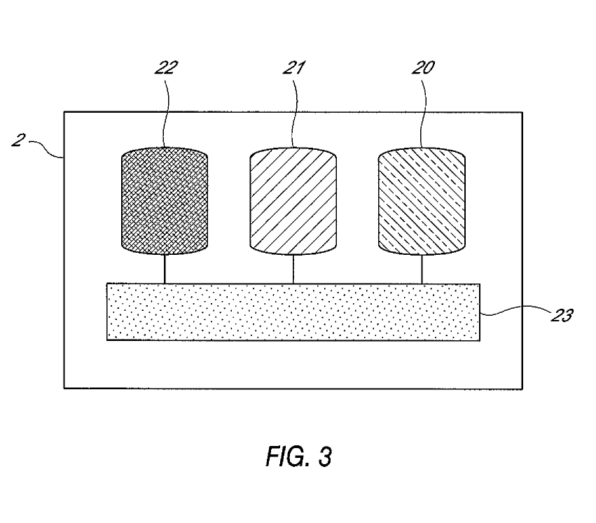

FIG. 3 shows a diagram of the server 2 of the system of the present invention. The server 2 comprises a processor 23 controlling the rest of the elements of the server. The server 2 or service platform communicates with the location device 1 through a communications channel 5 provided on the wireless communications network 3. On this communications channel 5 the server 2 can automatically provide the portable device 1 GPS assistance (A-GPS) information, occasional location requests for the on demand mode (which is explained below), receive information from the device (location, change of state . . . ). The A-GPS assistance information is periodically provided. The server 2 receives information from the location device 1 on the communications channel 5, as explained below. This same communications channel 5 can also be extended to the AMC 9 from the device 1, passing through the server 2. Furthermore, and independently of this communications channel 5, there can be another communications channel 10 between the server 2 and the AMC 9 which is useful for managing alerts, as shown in FIG. 1.

The server 2 also comprises a GPS assistance information sub-system 20, including a database necessary for sending the GPS assistance information and in charge of the management for obtaining, treating and sending said information to the device 1. The information of this sub-system 20 is obtained by means of the connection to a GPS reference network containing information on the spatial/temporal situation of the GPS satellites.

The server 2 also comprises a geographic information sub-system 21 (commonly known as GIS: Geographic Information System) comprising a cartographic database including the necessary maps whereby a response will be given from the server 2 of the system to the user 6. This sub-system manages all the actions relating to the cartography request, positioning on the cartography of the location of the device, path, geocoding (conversion of coordinates into street/number and vice versa).

The server 2 further comprises a user management sub-system 22 including a database with the information associated to such users. Said sub-system 22 is used at least for the management of the registration, cancellation, permissions, privacy, security, spatial temporal, configurations of the device 1, predefined areas, information related to the management of the alerts. Information associated to the remote medical service which the user 6 provides on the possible carrier of the device 1 can also be included in this sub-system.

This type of management is always closely related or is necessary in the location services (LBS, Location Based Service).

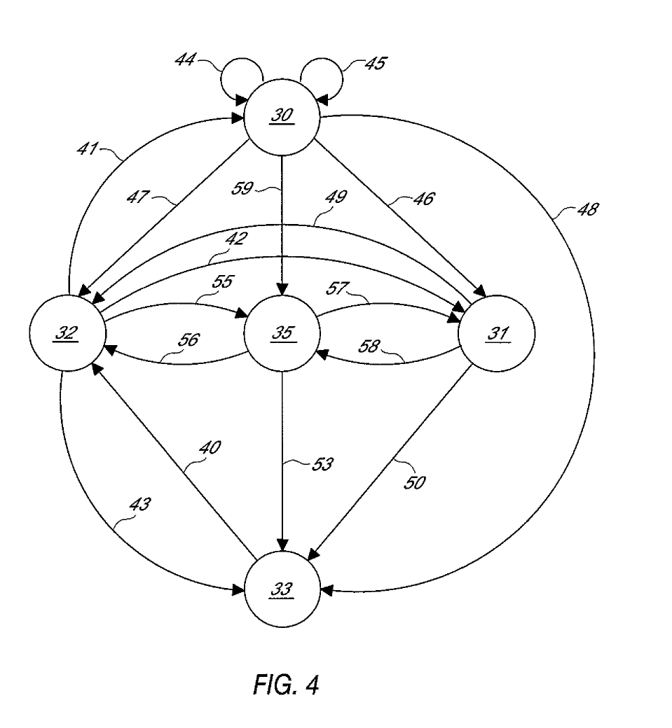

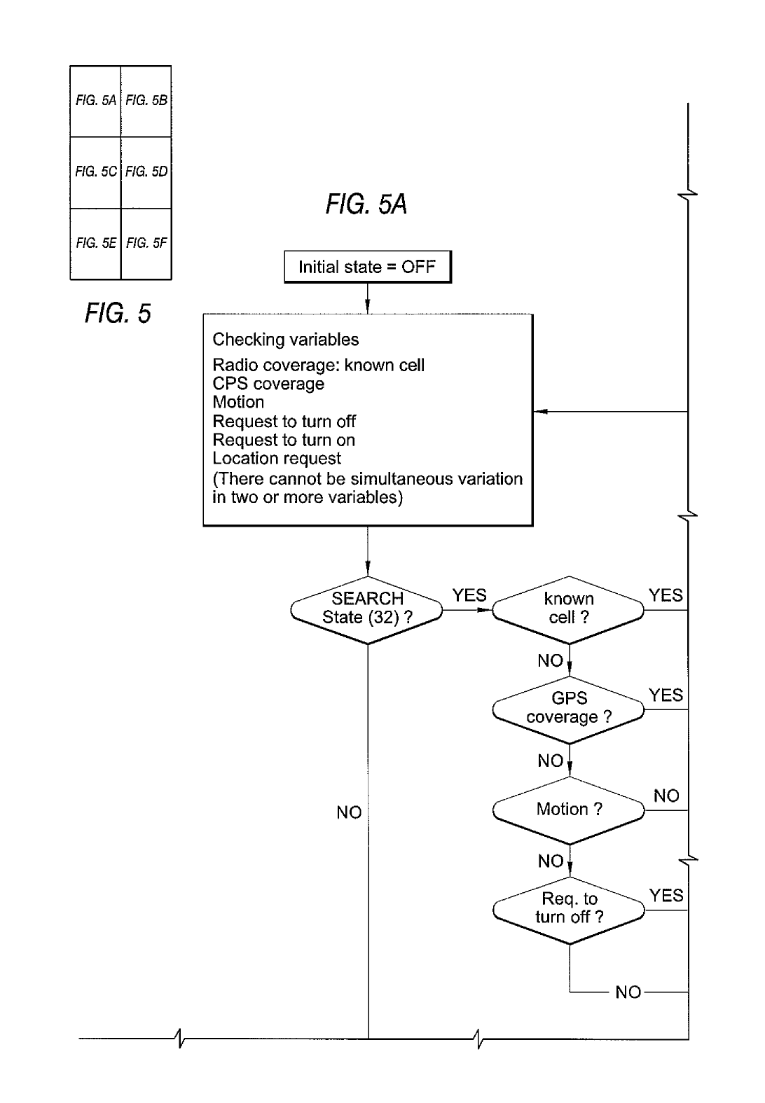

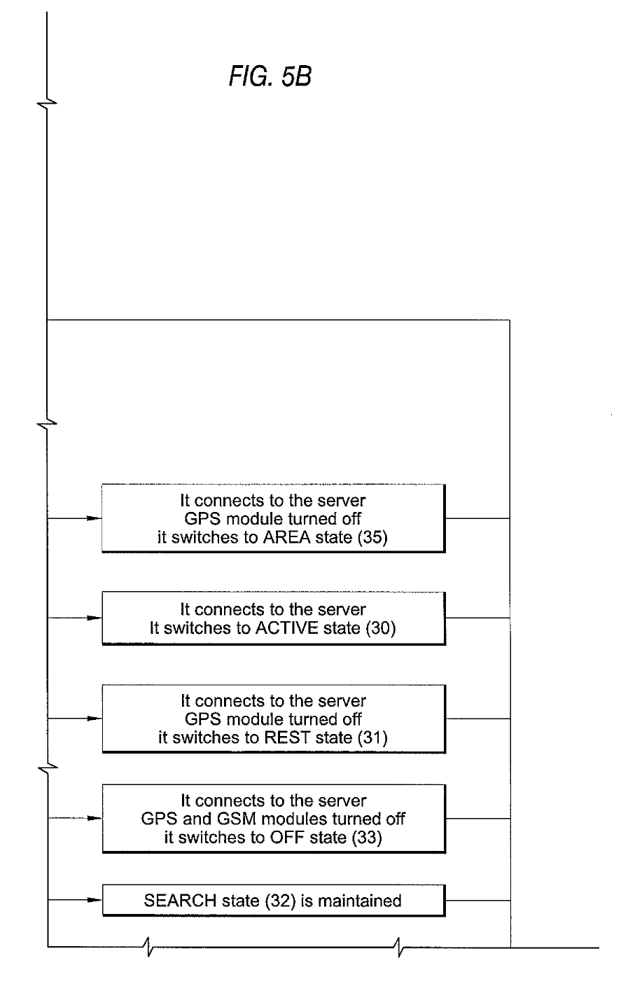

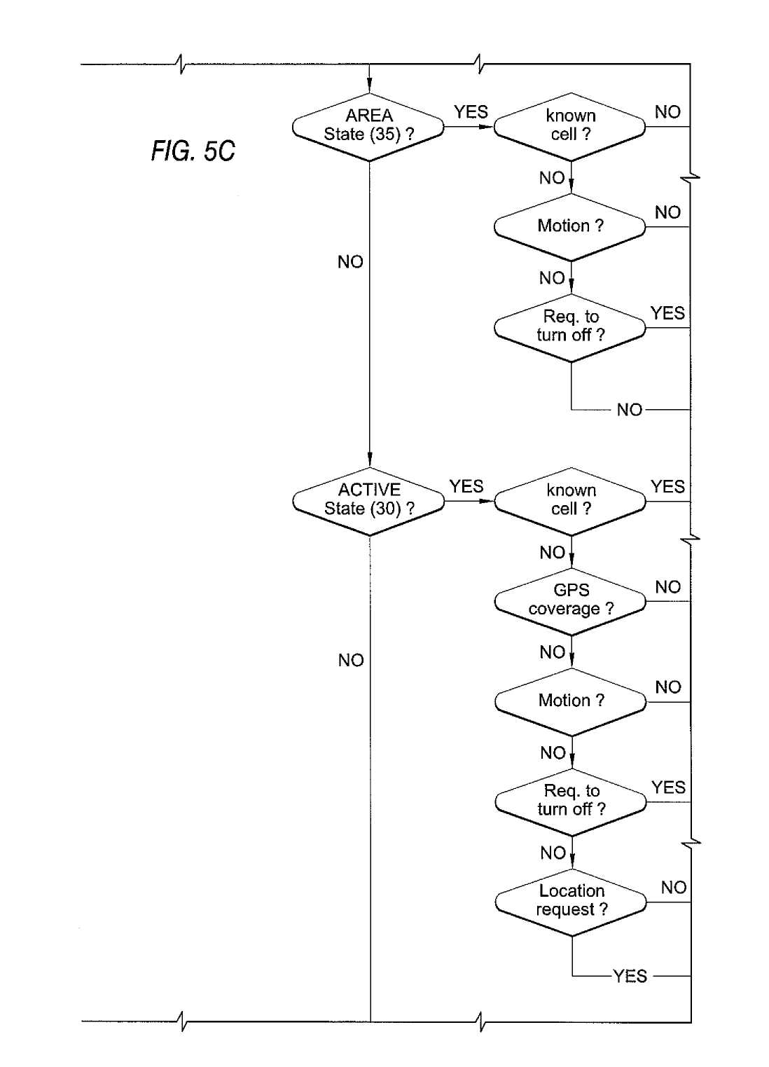

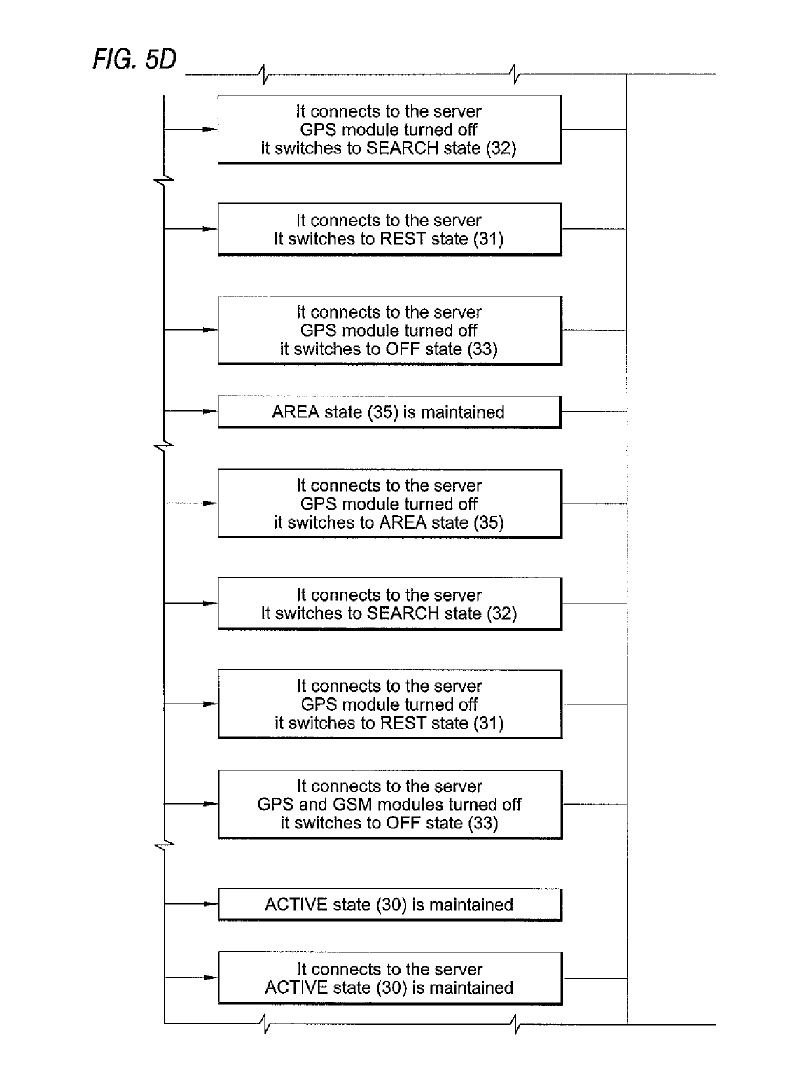

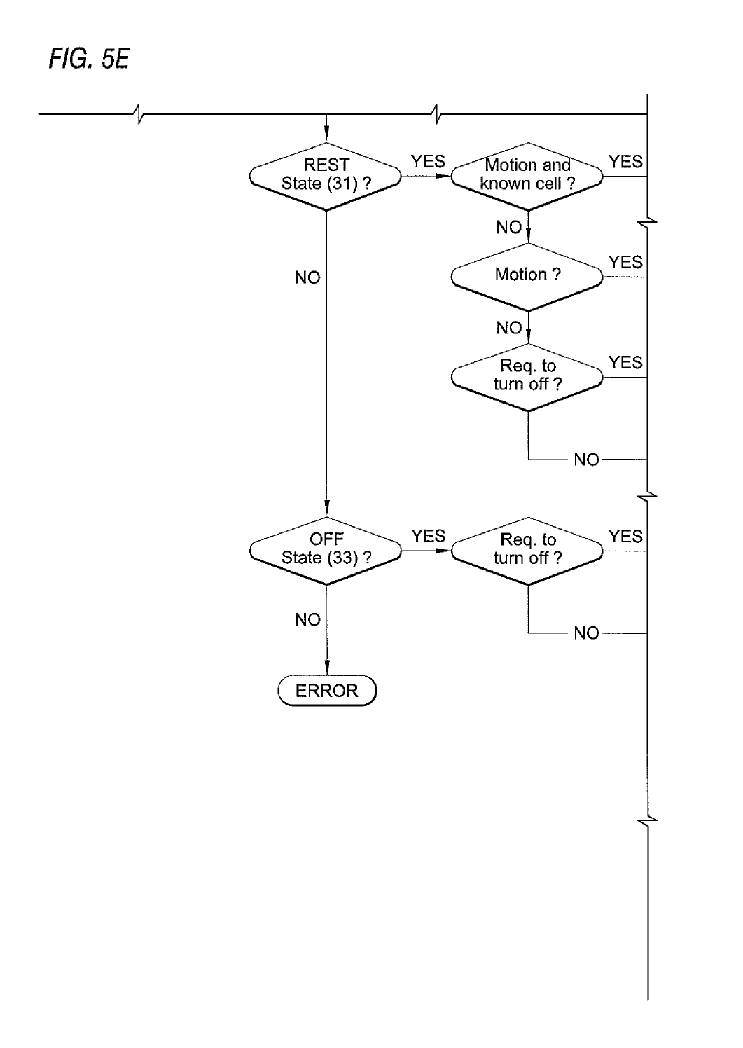

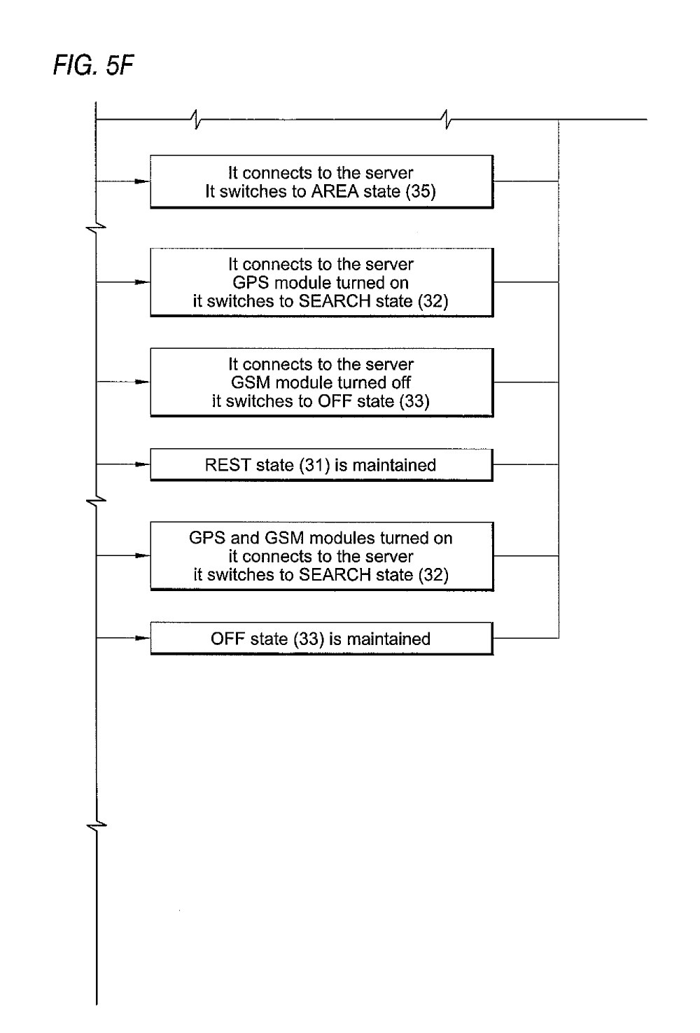

The location method from an operating algorithm of the system of FIG. 1 is detailed below. This operating algorithm is exemplified in the state diagram of FIG. 4. FIG. 5 shows the flow chart of the operating algorithm of the system of FIG. 1. In other words, FIGS. 4 and 5 show two possible alternatives for explaining the operating algorithm.

The location device 1 can be in one of the five following states explained below: ACTIVE state 30, REST state 31, SEARCH state 32, AREA state 35 and OFF state 33.

The reasons for the transitions between states 30, 31, 32, 33, 35 are the following:
loss/recovery of GPS coverage;
absence/recovery of motion (detected through the information obtained from the motion sensor 14 of the device, which is always available, and from the speed of the device obtained from the A-GPS positioning module 11 thereof, which is only available is it has GPS coverage);
known/unknown cell of the mobile communications network 3;
turning on/turning off of the device 1, either because the battery is used, due to the use of the encoded key (by means of USB for example), or due to the use of any button of the device 1 designed for that purpose, or due to a request from the server 2 of the user 6.

The actions which the location device 1 can carry out are:
turning on/turning off/hibernating the A-GPS location module 11;
turning on/turning off/hibernating the microprocessor 15;
turning on/turning off the transmission/receiving module 12;
turning on/turning off the motion sensor 14;
connecting to the server 2 for:
   Sending the last location which is available in the A-GPS positioning module 11 and the time associated to said location (note that provided that the device has the A-GPS location module turned on and has GPS coverage it is continuously calculating its own position, among which data GPS speed, date and time are included).
   Sending the locations, if any, stored in the local memory 16 of the device (this occurs when coverage of the wireless network 3 has been lost and the device, due to the operating mode it has, continues storing locations locally, or because it has thus been defined according to the process).
   Sending from the location device 1 to the server 2 a change of state of the device 1, in the event that said transition between states exists.
waiting for the recovery of the signal of the mobile communication network 3, in the event that it has been lost.

As mentioned previously, the A-GPS assistance information is sent automatically and, preferably, periodically from the server 2 to the location device 1, through the communications channel 5 existing between both elements 1, 2, over the wireless communication network 3. As a result of this A-GPS assistance information, the location device 1 can carry out locations in a shorter time period than that necessary with systems using (autonomous) conventional GPS systems. This further involves savings in the battery of the location device 1 and a subsequent increase of autonomy over time.

Furthermore, when the location device 1 loses coverage of the wireless communications network 3, the device 1 continues operating according to the defined method and locally storing in the memory 16 the generated frames (for example GPS position frames, state transition frames), until recovering the coverage of the wireless communications network 3. When it is recovered, the device 1 can now be connected to the server 2, send it the stored information, if any, check if there is a request to change the operating mode in the server.

Each of the four states shown in FIG. 4 is detailed below:

### OFF State (33)

This OFF state 33 is the state in which the location device 1 is completely turned off, i.e. both the A-GPS positioning module 11 and the transmission/receiving module 12, the microprocessor 15 and the motion sensor 14, are turned off or disconnected (with no energy consumption).

There is only one possible transition in this OFF state 33: the transition occurring when, upon turning on the device 1, it switches to the SEARCH state 32.
1) Transition 40: If the device 1 is turned on being in the OFF state 33, the device switches to the SEARCH state 32. The actions carried out are: Turning on the GPS positioning module 11 and the transmission/receiving module 12, connecting with the server 2 and informing that it has switched to the SEARCH state 32.

Note that during this transition 40, in the event that the device 1 has outdated A-GPS information, the open connection 5 with the server 2 can be used to update it.

### SEARCH State (32)

This SEARCH state 32 is the state in which the device 1 has both the A-GPS positioning module 11 and the transmission/receiving module 12 turned on. In this state the device 1 is searching for coverage. It initially discriminates according to the coverage of the wireless radio network 3 in the event that the cell or base station from which it receives service is locally stored in the internal memory 16 of the device 1. The second condition that the device 1 checks in this state is the state of the GPS coverage. If, in this state 32, a location request is received from a user 6 (shown in FIG. 1), the server 2 can provide the user 6 with the last location stored of the location device 1 and inform him or her that the location device is out of GPS coverage at that time.

There are four possible transitions 41, 42, 43, 55 from this state 32:
1) Transition 55: While searching for GPS coverage, if the device 1 switches to receiving coverage of the wireless or mobile communications network 3 from a cell or base station which it has stored and associated to an area, the device 1 switches to an AREA state 35. The actions carried out are: connecting to the server 2 to inform that it is switching to the AREA state 35 and turning off the A-GPS positioning module 11.
2) Transition 41: If GPS coverage is obtained, the device 1 switches to the ACTIVE state 30. The device 1 is connected with the server 2 and actions associated to this transition 41 are carried out to check what happened during the period in which it was without GPS coverage. The A-GPS positioning module 11 and transmission/receiving module 12, which were turned on, continue to be on.
3) Transition 42: If the device 1 detects, through the motion sensor 14, the absence of motion (i.e. if the device 1 has stopped), the device 1 switches to the REST state 31. Note that the decision for this transition 41 is made only from the information of the motion sensor 14, because since there is no GPS coverage it is impossible to obtain speed data from the A-GPS positioning module 11. Before entering this state 31, the device 1 connects to the server 2 to inform it that its state changes to the REST state 31 and the A-GPS positioning module 11 and the microprocessor 15 also switch to Hibernated. The transmission/receiving module 12 remains turned on so that it is always possible to receive a voice call in the device 1.
4) Transition 43: If the device 1 is completely turned off, either because the battery 13 is used up or due to the use of a button of the device 1 designated for that purpose, or due to a request from the server 2 of the user 6, or due to the manipulation by its carrier through the use of the USB key 18, the device 1 switches to the OFF state 33. The actions that are carried out are the following: connecting with the server 2 to inform it about the OFF state 33 it is switching to and turning off the transmission/receiving module 12 and the A-GPS positioning module 11. If, for example, the device 1 has no battery left, it is interesting for the server 2 to know this in case a user 6 is attempting to locate the device 1, in order to be informed of this.

### AREA State (35)

This AREA state 35 is the state in which the device 1 has the transmission/receiving module 12 turned on and the A-GPS positioning module 11 turned off and is receiving service from the wireless radio network from a cell or base station which the device 1 has locally stored. If during the AREA state 35 the server 2 receives a location request from the device 1 by a user 6, the server can return the position information associated to the area without having to contact the device 1. The server 2 has a location associated to AREA 35. Furthermore, since the device 1 has the A-GPS positioning module 11 turned off, it increases the autonomy of the device 1, the service being able to provide a precise position or location.

There are three possible transitions 53, 56, 57 from this AREA state 35:
1) Transition 56: If the device 1 stops receiving coverage of the wireless network 3 from a cell or base station which it has stored to the area in which it is located, the device 1 switches to a SEARCH state 32. The actions carried out are: connecting to the server 2 to inform that it is switching to the SEARCH state 32, turning on the A-GPS positioning module 11.
2) Transition 57: If the device 1 detects, through the motion sensor 14, the absence of motion (i.e. if the device 1 has stopped), the device 1 switches to the REST state 31. Note that the decision for this transition 57 is made based only on the information of the motion sensor 14, because since the GPS positioning module 11 is not turned on it is impossible to obtain speed data from said module. Before switching to this new REST state 31, the device 1 connects to the server 2 to inform it of this. The state of the modules, that of A-GPS positioning 11 turned off and that of transmission/receiving 12 turned on, is maintained; however the microprocessor 15 switches to a hibernated state.
3) Transition 53: If the device 1 is completely turned off, either because the battery 13 is used up, or due to the use of any button of the device 1 designated for that purpose, or due to a request from the server 2 of the user 6, or due to manipulation by its carrier through the use of the USB key 18, the device 1 switches to an OFF state 33. The actions which are carried out are: connecting to the server 2 to inform it about the OFF state 33 it is switching to and turning off all its modules: the transmission/receiving module 12, the microprocessor 15 and the motion sensor 14. If, for example, the device 1 has no battery left, it is interesting for the server 2 to know this in case a user 6 is attempting to locate the device 1, in order to be informed of this.

### ACTIVE State (30)

This ACTIVE state 30 is the state in which the device 1 has both the A-GPS positioning module 11 and the transmission/receiving module 12 turned on, and it further has GPS coverage.

In this ACTIVE state 30, the device 1 can be self-located for two reasons: because there is a specific request communicated from the server 2 (transition 45) or because there is a pre-programmed request that is repeated every certain time interval Tx (transition 44).

The first type of self-location, i.e. transition 45, corresponds to an on demand operating mode, which will be explained below.

The second type of self-location, i.e. transition 44, corresponds to a tracking operating mode, which will also be explained below.

After the self-location 44, 45 of the device 1, the latter communicates with the server 2 to send the last location obtained from the A-GPS positioning module 11.

There are four possible transitions 46 47 48 59 from this state 30 to other states:
1) Transition 46: this transition is shown in FIG. 4 with reference number 46 and occurs from the information obtained from the motion sensor 14 of the device 1, and because a null speed of the device has been obtained from the A-GPS positioning module 1. Once this decision is made, the device then communicates with the server 2 to send the last location available in the A-GPS positioning module 11 and informs on the REST state it is switching to. It further switches to the Hibernation of the A-GPS positioning module 11 and of the microprocessor 15. The transmission/receiving module 12 remains turned on so that it is always possible to receive a voice call in the device 1.
2) Transition 47: If GPS coverage is lost, the device 1 switches to a SEARCH state 32. This transition is shown in FIG. 4 with reference number 47, and the following actions are carried out by the device 1: connecting with the server 2 to inform that it switches to the SEARCH state 32, and to send the last A-GPS location available in the A-GPS positioning module. In the event that there is a location attempt or request for locating the device 1 by a user 6, the server 2 can give the user 6 the last stored location it has (together with the time at which it occurred) and informing that the device 1 is outside GPS coverage at that time. The A-GPS positioning module 11 and transmission/receiving module 12 are still turned on in said transition 47.
3) Transition 48: If the device 1 is turned off completely, either because the battery 13 is used up, or due to the use of any button of the device 1 designed for that purpose, or due to a request from the server 2 of the user 6, or due to manipulation of its carrier through the use of the USB key 18, the device 1 switches to an OFF state 33. The actions which are carried out are: connecting with the server 2 to inform about the OFF state 33 it is switching to and if the battery is used up, sending the last location available in the A-GPS positioning module 11 and turning off the transmission/receiving module 12 and the A-GPS positioning module 11. If during state 33 the server 2 receives a location request for locating the device 1 from a user 6, the server can return the last location of the device 1 before being turned off, informing that it is in the OFF state and that this is because of the battery being used up or because of a decision made by the carrier of the device.
4) Transition 59: If the device 1, while it is in the ACTIVE state 30, receives coverage of the wireless or mobile communications network 3, from a cell or base station which it has stored and associated to an area, the device 1 switches to an AREA state 35. The actions carried out are: connecting to the server 2 to inform that it is switching to the AREA state 35 and turning off the A-GPS positioning module 11.

### REST State (31)

This REST state 31 is the state in which the device 1 has the A-GPS positioning module 11 and the microprocessor 15 in the Hibernated operating mode (low consumption), the transmission/receiving module 12 turned on and the motion sensor 14 turned on and working in normal mode. Since the GPS positioning module 11 and the microprocessor 15 are in the low energy consumption mode, autonomy of the device is prolonged.

It must be pointed out that in this REST state 31, the system has an optimized operation because if a location request reaches the server 2 from a user 6, the server 2 carries out the following actions depending on:
If its prior state was the ACTIVE state 30: It responds with the current location of the device 1, despite the fact that specific communication with such device has not even been needed and that the device is in REST, in a hibernated mode (low consumption), prolonging the autonomy thereof.
If its prior state was the SEARCH state 32: It responds with the last stored location and with the hour associated thereto, notifying the user 6 that since GPS coverage has been lost, it is possible that this sent location is not the current location (because its prior state was the out of GPS coverage state). The user 6 is further informed that as soon as the device 1 recovers coverage of the GPS network and of the wireless communication network 5, it will be located and updated information will be given to the user 6.
If its prior state was the AREA state 35: It responds with the location associated to the area in which the device switches to this REST state 31, despite the fact that the express communication with same was not even necessary and that it is located in the REST state 31, in a hibernated (low consumption) mode, extending the autonomy thereof.

There are three possible transitions 49, 58, 50 in this REST state 31:
1) Transition 58: If the device 1 detects motion through the motion sensor 14 and checks that it is receiving service from the wireless network from a known cell or base station, it switches to the AREA state 35. In this switching the state of the modules, that of transmission/reception 12 turned on and that of A-GPS positioning 11 turned off, is maintained, however the microprocessor 15 must be turned on.
2) Transition 49: it occurs when, upon the device 1 recovering the motion and service from the wireless network 3 is not received from a cell or base station locally stored in the device 1, the device switches to the SEARCH state 32. This transition is shown in FIG. 4 by reference number 49, and the actions which the device 1 carries out are the following: connecting with the server 2 to inform about the switching to the SEARCH state 32 and turning on the A-GPS positioning module 11 and the microprocessor 15.
3) Transition 50: If the device 1 is completely turned off, either because the battery 13 is used up, or due to the use of any button of the device 1 designed for that purpose, or due to a request from the server 2 of the user 6, or due to manipulation of its carrier through the use of the USB key 18, the device 1 switches to an OFF state 33. The actions which are carried out are: connecting with the server 2 to inform about the OFF state 33 it is switching to and turning off the following modules: the transmission/receiving module 12, the microprocessor 15 and the motion sensor 14.

In summary:
When the device 1 is in the OFF state 33, the A-GPS positioning module 11, the transmission/receiving module 12, the motion sensor 14 and the microprocessor 15 are turned off.
When the device 1 is in the SEARCH state 32, the A-GPS positioning module 11, the transmission/receiving module 12, the motion sensor 14 and the microprocessor 15 are turned on.
When the device 1 is in the AREA state 35, the transmission/receiving module 12, the microprocessor 15 and the motion sensor are turned on and the A-GPS positioning module 11 is turned off.
When the device 1 is in the ACTIVE state 30, the A-GPS positioning module 11, the transmission/receiving module 12, the motion sensor 14 and the microprocessor 15 are turned on.
When the device 1 is in the REST state 31, the A-GPS positioning module 11, the transmission/receiving module 12 and the microprocessor 15 are hibernating, whereas the motion sensor 14 and the transmission/receiving module 12 are turned on.

The possible states of the device 1 and the transitions it may switch to have been described up to this point. The two possible operating modes of the entire system are described below in relation to the information a user 6 receives regarding the position of the device 1. These two modes are: “on demand” and “tracking”. Said user 6 must obviously be authorized to obtain said information, which can all be verified in the user management sub-system 22. Authorization itself is not the object of the present invention.

For an authorized user 6 to be able to access the information on the location of the device 1, the user 6 must connect with the server 2 through a communication network 7. This network 7 can either be a data network from a personal computer, for example Internet, or a mobile communication network from a mobile terminal or PDA, such as GSM, GPRS. The user 6 can also receive (for example, in his or her mobile telephone or PDA), a map with the information of the location of the device 1. The user can also contact a service provider help center by making a telephone call.

The user 6 can further carry out the entire configuration of the device 1, change the operation mode, including the management and configuration of alerts (definition, activation/deactivation), through the same possible accesses to the server 2.

If the user 6 requests an operation mode change for the device 1, the server 2 sends said request through the communications channel 5 and the device receives the operation mode change request since the transmission/receiving module 12 is always turned on. In the event that the device is not receiving service from the wireless network 3, either because it is outside the coverage or because it is turned off, the request will be placed in a FIFO queue in the server 2 and it will be sent upon receiving service from the wireless network 3.

It must be noted that the device 1 can have several cells or base stations of the wireless radio network 3 locally stored, corresponding to several predefined areas in the device. Each of these areas in turns has an associated position and all of this is stored in the server 2.

The way to define a new area is the following:
a call is made from the Panic Button 60 to the AMC 9 from the device 1, at the same time that a data connection is set up on the data network 5 with the server 2. During the course of this call associating the data from the cells or base stations provided by the device 1 in the server 2 is managed from the AMC 9 and the server 2 with the position that:
   is provided directly by the device 1 from its location module 11 through the data connection: GPS position [lat,long]
   is provided by the user from the information of [street,number,city]
After these actions, the cell(s) associated to the area are locally stored in the device 1 and the [cell(s)/area/position] relationship is stored in the server 2. As has been mentioned there can be several predefined areas in the method. The data of the power received from each base station or cell is also taken into account for this process of storing known areas.

The user 6 is preferably a person or organization in charge of taking care of and/or supervising the person carrying the device 1.

### On Demand Mode

This mode, also referred to as request-response mode, is the basic operating mode of the system. The user 6, who is the end customer, requests the location of a device 1 by means of any possible type of access which allows connecting with the network 7, such as a computer with access to Internet (web page), mobile telephone, PDA. The server 2 then responds, if possible, with the sending of a map showing the current location of the device 1, or with a corresponding message in the event that the location information of the device 1 could not be provided at that time.

In this on demand mode, there is no established time for the device 1 to carry out self-locations (transitions 44 and 45 of FIG. 4). Therefore, the device 1 does not periodically carry out self-locations. The server 2 responds to occasional location requests by the user 6.

In this mode, the device 1 places the frames which must be sent in an outgoing FIFO queue, such that in the event of a lack of coverage of the wireless network 13, the frames are locally stored and subsequently sent to recover GPRS coverage.

### Tracking Mode

This mode is used to continuously track the device 1. In other words, the system is continuously monitoring the device 1, and therefore, the person carrying it.

In this mode, the device 1 is self-located every certain time period “Tx” that can be configured in the server 2 and sends its location to the server 2. This mode further allows any occasional request from the server 2, i.e. it includes the possibilities offered by the on demand mode. If the device 1 loses coverage of the communication network 3, such that it is not possible to send the location to the server 2, the device continues self-locating itself every period “Tx” defined above and storing in its local memory 16, so that later when it recovers coverage of the mobile network, it can communicate with the server 2 and send locally stored the locations. At this time it sends to the server all the locations stored in the memory 16 of the device 1.

In this mode, the device 1 places the frames which must be sent in an outgoing FIFO queue, such that in the event of a lack of coverage of the wireless network 13, the frames are locally stored and subsequently sent to recover GPRS coverage.

The user 6 can switch between both modes, as needed. The server 2 informs the device 1 when the state is switched from on demand to tracking, or vice versa.

In this tracking mode, instead of sending the position every time a self-location is performed (i.e. every period “Tx”, the positions can be stored locally in the internal memory 16 of each interval “Tx”, but the communication channel 5 only opens every one greater time interval “Ty” (Ty>Tx)), a group of them can optionally be sent later simultaneously and in a compressed manner so as to reduce the battery consumption of the device 1 and thus increase its autonomy.

The user 6 can therefore locate one or more devices 1 belonging to several persons from the server 2 in real time, and carry out a tracking in real time and generate reports or simply carry out occasional requests of the devices.

In addition, the device 1 of the present invention allows the user 6 to configure/activate/deactivate a series of alerts through different accesses, such as from a personal computer, from a portable device, through a telephone call and others for example. Each time an alert is configured, the server 2 informs the device 1 of this through the data connection 5 existing on the communication network 3, except for the motion alert.

All the alerts are generated in the device 1 sending the information corresponding to the server 2 through the data connection 5 existing on the communications network 3, except for the motion alert which is generated directly in the server 2.

In all the possible alert cases explained below, once the alert is generated, either from the device itself or from the server 2, the system allows informing the user 6 of the event in different ways, by means of a text message to his or her mobile telephone, by means of an e-mail to his or her e-mail address, by means of a call.

It must be noted that the generation and management of the alerts are independent of the operating mode of the device 1.

After generating any of the alerts explained below, the alert will be considered ended when the user 6 thus indicates it through the accesses already defined for the configuration of the service.

The panic, low battery and fall alerts are always active, their deactivation being impossible due to the care orientation of the defined service.

### 1) Panic Alert

This alert is always active and its deactivation is not allowed. The alert is generated by the actuation of the interface of the panic button 60 and will always have priority over the rest of the possible alerts.

As has been previously mentioned, the generation of this alert has associated thereto the switching to the “tracking” operation mode in the event that the device 1 was in an “on demand” mode, until the alert is deactivated.

### 2) Geographical Alerts

They allow configuring geographical areas and knowing the exit, entrance or entrance/exit of the device 1 in said area in real time. The number of possible simultaneously active geographical alerts can be configured.

Each time the user 6 configures a geographical alert, the server 2 sends the information associated to the geographical alert to the device 1, the activation/deactivation of the alert, defined geographical area, type of geographical alert (entrance, exit or entrance/exit), to the device 1. This is necessary because the alert is generated directly in the device 1.

In the event that a geographical alert is active and meets the condition of the alert, the device 1 generates a geographical alert and informs the server 2 of this. The server 2 sends an automatic warning with the information of the alert to the external Alert Management Center 9, if the user has thus configured it.

### 3) Speed Alert

This alert allows the user 6 to configure a maximum speed for his or her device 1.

Every time the user 6 configures a speed alert, the server 2 sends the information associated to the geographical alert to the device 1, the activation/deactivation of the alert and maximum speed, to the device 1. This is necessary because the alert is generated directly in the device 1.

The GPS speed is among the data which the GPS module 11 of the device 1 has, which is used for generating the alert by comparing it with the maximum speed configured by the user 6.

In the event that this alert is active and the device 1 exceeds the maximum configured speed, this alert is generated from the device 1 to the server 2. The server 2 sends an automatic warning with the information of the alert to the external Alert Management Center 9, if the user has thus configured it.

### 4) Low Battery Alert

This alert allows the user 6 to configure a minimum battery 13 threshold below which the device generates the alert. This alert, as occurs with the panic and fall alerts, is always active and configured with an initial value of 20% the capacity of the battery 13 by default.

Every time the user 6 configures a low battery alert, the server 2 sends the information associated to the geographical alert to the device 1, the minimum battery capacity threshold to the device 1. This is necessary because the alert is generated directly in the device 1.

In the event that the device 1 has a battery level less than that defined as the threshold, this alert is generated from the device 1 to the server 2. The server 2 sends an automatic warning with the information of the alert to the external Alert Management Center 9, if the user has thus configured it.

### 5) Motion Alert

This alert is generated directly from the server 2 without the intervention of the device 1, unlike the rest of the defined alerts.

The functionality of this alert provides the service with the ability to detect the motion of the device 1.

The alert is generated as follows: The latter being active, the server 2 generates the alert when, the device 1 being in the REST state (31), it detects motion through the motion sensor 14 and switches state. The server 2 sends an automatic warning with the information of the alert to the external Alert Management Center 9, if the user has thus configured it.

### 6) Fall Alert

This alert allows detecting a possible fall of the carrier of the device 1 and warns of this. This alert is always active, as occurs with the panic and low battery alerts.

The device 1 has example patterns of falls obtained from the typical behavior of a motion sensor stored in its local memory 16. If the microprocessor 15 detects similarity in the behavior of the motion sensor 14, the device 1 generates the fall alert to the server 2. The server 2 sends an automatic warning with the information of the alert to the external Alert Management Center 9, if the user has thus configured it.

The generation of any of the described alerts can be reflected visually and/or with sounds through the interfaces for accessing the service of the user 6 in the alert area and of the external support AMC, if it exists.

In the configuration of the device 1 the user 6 can block the following functionalities of the service:
Hands-free: Said functionality can be blocked so that it is always active or deactivated and cannot be switched to through the use of the interface/button 64.
Call volume: Said functionality can be blocked so that the volume of the ongoing call cannot be raised/lowered through the use of the interface/button 63 and 65.
Turning off the telephone: Said functionality can be blocked so that the device can only be remotely turned off and through the mini-USB key 18, eliminating the possibility of turning off by holding down the interface/button 61.

As for the panic button, only the platform can send a frame to be able to change the CRA number of the device in exceptional situations.

The location service provided by the invention can be used in both personal and professional environments related to the field of remote care for people with specific needs.

The access to the service can be accessed through a personal computer or mobile terminal (telephone, PDA) with Internet access. This access allows the user 6 to carry out all steps associated thereto and many already described: Configuration of the device and operation mode; Configuration of the alert service; Information of the locations of the device (routes and occasional positions) on digital cartography in two and three dimensions; route reports and alert reports.

In view of this description and the set of drawings, a person skilled in the art can understand that the invention has been described according to some preferred embodiments thereof, but that multiple variations (in the system of satellites, the positioning module, wireless communication networks, etc.) can be introduced in said preferred embodiments, without departing from the object of the invention as it has been claimed.

1. A location method for locating a portable device from a server configured to communicate with said portable device through a wireless communications network, in which said portable device comprises a transmission/receiving module, an A-GPS positioning module and a microprocessor configured to manage said modules, in which the method comprises the steps of:
sending GPS assistance information from the server to the portable device through said wireless communications network;
obtaining in the A-GPS positioning module of the portable device a GPS signal from a satellite system;
calculating in said portable device a location of the device itself from said GPS signal and from the GPS assistance information sent by the server;
sending said location to the server from the transmission/receiving module through said wireless communications network;
characterized by the steps of:
when the portable device is stopped, hibernating the A-GPS positioning module and the microprocessor, maintaining the transmission/receiving module turned on; and
when the portable device is in an area in which it is receiving service from said wireless communications network from a cell recognized by said device and stored in a memory thereof, turning off the A-GPS positioning module, such that the server can provide position information associated to said area without having to interrogate the device, thus saving the battery and increasing the autonomy of the portable device.

2. The method according to claim 1, in which the step of hibernating said module and said microprocessor is carried out by the portable device itself according to at least the information obtained from motion sensor means which can detect the motion of said device.

3. The method according to claim 1, in which the portable device calculates, from said information comprised in said GPS signal, the speed of the device itself, said information relating to the speed of the device being used to make the decision to hibernate said module and said microprocessor.

4. The method according to claim 1, in which, before the step of hibernating said module and said microprocessor, the device sends the server:
the final location obtained by the A-GPS positioning module,
previous locations stored in the device, if any;
and informs the server that it is going to hibernate said module and said microprocessor.

5. The method according to claim 1, in which said calculation of the location of said device is carried out in an on demand mode, i.e. as a response to an occasional request from a user, which occasional request is carried out through said server.

6. The method according to claim 1, in which said calculation and sending of the location of said device is carried out in a tracking mode, i.e. it is periodically repeated, provided that there is GPS coverage, every certain time period, upon request of a user who determines said time period, through said server.

7. The method according to claim 6, in which if the device loses coverage of the wireless communications network, the device stores in a local memory all the locations calculated according to said tracking mode and which have not been sent to the server due to a lack of coverage of the wireless communications network, and they are sent to the server when the device recovers said coverage.

8. The method according to claim 5, comprising the step of changing the mode for obtaining locations of the device from an on demand mode, i.e. occasional requests made by said user, to a tracking mode, i.e. periodical requests every certain time period, upon request of said user, who determines said time period, through said server.

9. The method according to claim 6, comprising the step of changing the mode for obtaining locations of the device from the tracking mode, i.e. periodic requests made every certain time period, to an on demand mode, i.e. occasional requests made as a response to an occasional request from said user, which request is made through said server.

10. The method according to claim 8, in which every time the device connects with the server through said wireless communications network, it checks if in said server there is a request demanded by a user for changing from the tracking mode to the on demand mode, or vice versa, and if that is the case, it performs said change.

11. The method according to claim 1, in which if GPS coverage is lost by the A-GPS positioning module, the A-GPS positioning module and the transmission/receiving module being turned on, the portable device sends the server:
the last location obtained by the A-GPS positioning module, and
previous locations stored in the device, if any;
and informs the server that GPS coverage has been lost.

12. The method according to claim 1, in which if the device begins to move after having been stopped and with the A-GPS positioning module hibernated, the following steps occur:
turning on the A-GPS positioning module,
informing the server that said module has been turned on and that it is attempting to obtain GPS coverage.

13. The method according to claim 1, in which the portable device can be turned off voluntarily by means of an encoded key or automatically due to the battery of the portable device being used up.

14. The method according to claim 13, in which the portable device, before being turned off:
informs the server that it is going to be turned off;
sends the server the last location obtained by the A-GPS positioning module and
sends the server previous locations stored in the device, if any.

15. The method according to claim 1, in which when the portable device is turned on, the following steps occur:
both the A-GPS positioning module and the transmission/receiving module are activated,
the device begins to search for GPS coverage, and
the device informs the server of this.

16. The method according to claim 1, in which when the portable device obtains GPS coverage and has the A-GPS module and the transmission/receiving module turned on:
it informs the server of this and
it sends its current location.

17. The method according to claim 6, in which if the portable device loses coverage of the wireless communication network and it is in motion, the device:
continues calculating its locations from said GPS signal and from the GPS assistance information sent, and
stores said locations in a memory of the device to be sent to the server when the device has recovered said coverage of the wireless communication network.

18. The method according to claim 1, in which each time the device sends the server any of the locations obtained in the A-GPS positioning module, it also includes the time associated to each of said locations.

19. The method according to claim 1, in which the server is configured to inform a user of the position of the portable device.

20. The method according to claim 19, in which the server sends said user the last position obtained by the portable device.

21. The method according to claim 19, in which if the device is stopped, the server sends the user the last position of the device that the server has stored, where said last position has been sent from the device to the server before hibernating the A-GPS positioning module.

22. The method according to claim 21, in which if before the device stops, it has both GPS coverage and coverage of the wireless communications network, it informs the user that the information of the location sent corresponds to the current position of the device.

23. The method according to claim 21, in which if before the device stops, it does not have GPS coverage, it informs the user that the information of the location sent may not correspond to the current position of the device, in which case said information corresponds to the last position that the device was able to calculate before losing GPS coverage.

24. The method according to claim 19, in which if the device is in motion but has lost GPS coverage, the server sends the user the last position of the device that the server has stored, in which said last position has been sent from the device to the server before losing GPS coverage, and the server informs the user that:
the information of the location sent may not correspond to the current position of the device, but rather it corresponds to the last position that the device was able to calculate before losing GPS coverage and
that the device is searching for GPS coverage.

25. The method according to claim 19, in which if the device is turned off, the server sends the user the last position of the device that the server has stored, and the server informs the user that:
the information of the location sent may not correspond to the current position of the device,
that the device is turned off.

26. The method according to claim 19, in which said user receives the position of the portable device from the server as a response a an occasional request initiated by the user.

27. The method according to claim 19, in which said user periodically receives the position of the portable device from the server every certain time, which can be configured in the system, and according to a prior agreement established for the automatic sending of locations.

28. The method according to claim 19, in which the user receives the position of the portable device in a manner which is chosen from among the following: shown on a cartographic map which can be accessed from a fixed terminal or a mobile terminal, shown in text format or by means of an audio file.

29. The method according to claim 19, which further comprises sending a user at least one alert related to the state of the portable device.

30. The method according to claim 29, in which said at least one alert is chosen from among the following group of alerts: motion alert, geographical alert, speed alert, low battery alert, panic alert and fall alert.

31. The method according to claim 30, in which said alert is a motion alert which is generated from the server.

32. The method according to claim 30, in which said alert is a geographic alert which allows configuring at least one geographical area and knowing the entrance and/or exit of the device in said area in real time.

33. The method according to claim 30, in which said alert is a speed alert which is generated if the device exceeds a previously configured speed threshold.

34. The method according to claim 30, in which said alert is a battery alert which is generated if the battery level of the device passes from being above a previously configured threshold to being below said threshold.

35. The method according to claim 30, in which said alert is a panic alert activated by the carrier of said device through an interface of said device.

36. The method according to claim 30, in which said alert is a fall alert detected through the motion sensor of the device.

37. The method according to claim 29, comprising the step of configuring the service and managing said alerts by the user by means of web access from a computer, from a mobile terminal or by means of telephone access.

38. The method according to claim 37, comprising the step of sending said alert from said server to a user by means of sending an SMS to the mobile of the user, by means of sending an e-mail to his or her e-mail address or by means of a voice call to his or her mobile or fixed telephone.

39. A portable device comprising:
A-GPS global positioning means configured to receive a GPS signal from a network of GPS satellites;
transmission/receiving means configured to connect with a wireless communications network and to receive therethrough, from a server, at least GPS assistance information and location requests;
a microprocessor which can control said A-GPS positioning means and said transmission/receiving means and comprising an internal storage memory;
in which said portable device can calculate its position from said GPS assistance information and from said GPS signal and to send said position to said server;
characterized in that
the portable device comprises motion sensor means which can capture information that can be used for hibernating or interrupting the hibernation of said A-GPS positioning module, according to the absence or presence of motion of the portable device and which can capture a measurement of the gravity.

40. The device according to claim 39, in which said motion sensor means comprise an accelerometer.

41. The device according to claim 39, further comprising a battery.

42. The device according to claim 39, further comprising an access interface.

43. The device according to claim 42, in which said access interface is a USB port.

44. The device according to claim 39, further comprising visual means for indicating the state of said battery, of said A-GPS positioning means and of said transmission/receiving means.

45. A system for locating a portable device comprising:
at least one portable device according to claim 39;
a server configured for communicating through a data channel with said portable device through a wireless communications network and for automatically providing said portable device GPS assistance information;
a remote manager node connected to said server through a data network, configured for remotely managing the device.

46. The system according to claim 45, in which said server comprises a GPS assistance information sub-system, in turn comprising a database which can store the actual assistance information, in charge of the steps for obtaining, treating and sending the GPS assistance information from the server to the device.

47. The system according to claim 45, in which said server further comprises a geographic information sub-system in turn comprising a cartographic database which can store maps, in which said geographic information sub-system is configured to manage actions related to cartography requests, positioning on said cartography of the location of the device, geocoding and reverse geocoding.

48. The system according to claim 45, in which said server further comprises a user management sub-system in turn comprising a database which can store information associated to the users, in which said user management sub-system is configured to manage the registration, cancellation, permissions, privacy, security and spatial temporal preferences of the users.

49. A computer program comprising computer program code means adapted to carry out the steps of the method according to claim 1 when the mentioned program is executed in a computer, a digital signal processor, an application-specific integrated circuit, a microprocessor, a microcontroller or any other form of programmable hardware.
